(19) United States
(12) Patent Application Publication
(10) Pub. No.: US 2008/0196917 A1
(43) Pub. Date: Aug. 21, 2008

(54) FLUID SUPPLY HOSE FOR A WINDSCREEN OR HEADLAMP WASHER SYSTEM OF A VEHICLE

(76) Inventors: Jurgen Hofmann, Melsungen (DE); Lutz Seyfarth, Wehretal (DE); Markus Bickel, Alt-Morschen (DE)

Correspondence Address: HANLEY, FLIGHT & ZIMMERMAN, LLC, 150 S. WACKER DRIVE, SUITE 2100, CHICAGO, IL, 60606, US

(21) Appl. No.: 12/032,239

(22) Filed: Feb. 15, 2008

(30) Foreign Application Priority Data
Feb. 16, 2007 (DE) 102007007761.2

(51) Int. Cl. F16L 11/12; H01B 7/00

(52) U.S. Cl. 174/47

(57) ABSTRACT

A fluid supply hose for a windscreen or headlamp washer system of a vehicle having an electric heating element, said heating element comprising a coaxial cable (2, 12) with an inner current conductor (3, 13) and an outer current conductor (5, 15) surrounding said inner conductor (3, 13), an insulator (4, 14) being provided between said inner (3, 13) and said outer conductor (5, 15). To provide a fluid supply hose of the type mentioned herein above the heating element of which is of a small and flow-enhancing design so that the fluid supply hose may have a smaller cross section, the inner current conductor (3, 13) is given a higher electric resistance than the outer current conductor (5, 15).

### CROSS-REFERENCE TO RELATED APPLICATIONS

This application claims Priority from German Application No. DE 10 2007 007 761.2, filed on Feb. 16, 2007.

### FIELD OF THE DISCLOSURE

The present invention relates to a fluid supply hose for a windscreen or headlamp washer system of a vehicle according to the preamble of claim 1.

On such type windscreen or headlamp washer systems, the fluid contained in the system freezes at frost temperature even if the fluid contains additives. In order to prevent the fluid from freezing, one loose single heating wire is provided in the fluid supply hose, electric power being applied to said heating wire for heating itself and the fluid when the outside temperature falls below 5° C.

This heating wire is laid in the form of a loop over the entire length of the fluid supply hose so that the two connecting ends of the heating cable are available at one point for connecting the power source. In the cross section of the fluid supply hose, the heating wire laid in the form of a loop is provided with two strands that occupy a lot of space on the one side and increase the flow resistance on the other side so that the fluid supply hose must be designed so as to have a size appropriate to ensure perfect fluid throughflow.

### BACKGROUND OF RELATED ART

An electrically heated hose for a windscreen washer system of a vehicle is known from the document EP 0 456 024 A1, a heating element formed from a coaxial cable being laid in the lumen thereof. This coaxial cable has an interior heating conductor made from copper and a conducting wire mesh disposed thereabout, also made from copper, an insulation being provided between the heating conductor and the wire mesh. At a free end of the heating element, the heating conductor and the wire mesh are electrically connected together. Even if the heating element known from the document EP 0 456 024 A1 already needs less space and causes less friction loss than other prior art heating elements, the need for space could be even further reduced.

### SUMMARY

In view thereof, it is the object of the present invention to provide a fluid supply hose of the type mentioned herein above in which the heating element is of a small and flow-enhancing design so that the cross section of the fluid supply hose may be smaller.

As a technical solution to this object, a fluid supply hose for a windscreen or headlamp washer system having the features of claim 1 is proposed. Advantageous developed implementations are recited in the dependent claims.

A fluid supply hose configured according to this technical teaching has the advantage that the main heating power is obtained at the inner current conductor as a result of the higher resistance. The result thereof is that the inner current conductor can be a relatively thin implementation, this reducing the space needed therefor. In practice, one tries to limit the diameter of the entire coaxial cable to 2 mm.

Depending on the type of vehicle, the fluid supply hose of the windscreen or headlamp washer system varies in length, this also calling for different heating power in order to keep the entire windscreen or headlamp washer system from freezing. Simultaneously, the diameter of the fluid supply hose should be the same for all the vehicle types in order to avoid unnecessary manufacturing and storage costs. In order to provide a heating element having an almost constant outer diameter and still having different heating power depending on the demand, the invention relies on the observation that the resistance must be adapted while the cross section remains unchanged. In a preferred embodiment, this is achieved in that the inner current conductor is made from a copper-nickel alloy, the nickel content varying as a function of use. In one application, the inner current conductor is made for example from a CuNi2, in another it is made from a CuNi6 and in still another application from a CuNi10 alloy.

Another advantage is that a thin heating element is easy to handle and also to mount as a result thereof.

In an advantageous developed implementation, the outer current conductor is made from a tin-plated or nickel-plated copper braid.

In still another preferred embodiment, the outer current conductor is not configured to be a mesh, but is rather wrapped about the insulator and, as a result thereof, about the inner current conductor as well. It has proved advantageous if the outer current conductor covers the insulator over 80% to 98%, preferably over 95%.

Further advantages of the fluid supply hose of the invention will become apparent in the appended drawings and in the following description of embodiments thereof. Likewise, the invention lies in each and every novel feature or combination of features mentioned above or described herein after. The embodiments discussed herein are merely exemplary in nature and are not intended to limit the scope of the invention in any manner.

### BRIEF DESCRIPTION OF THE DRAWINGS

In said drawings:

FIG. 1 shows a cross section of a fluid supply hose of a windscreen and headlamp washer system of the invention;

FIG. 2 shows a perspective view in partial section view of a fluid supply hose of FIG. 1;

FIG. 3 shows a perspective sectional view of a second embodiment of a heating element.

### DETAILED DESCRIPTION

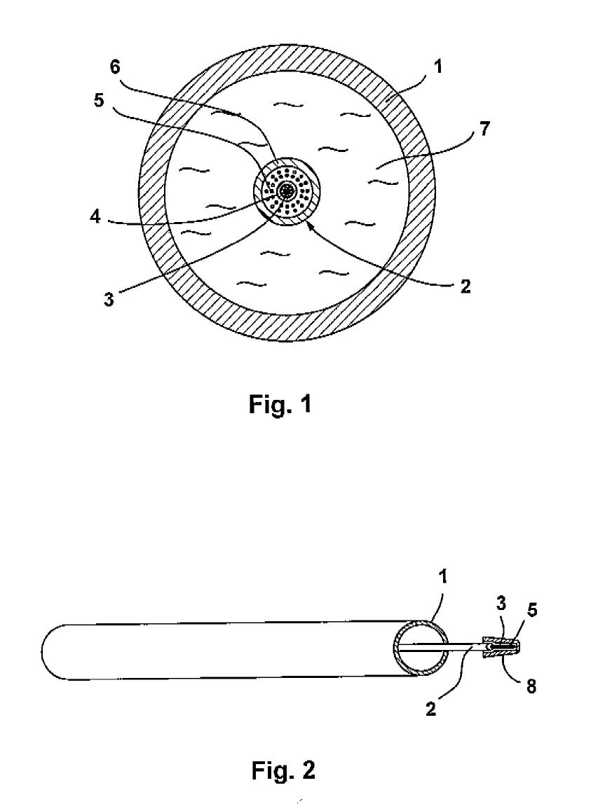

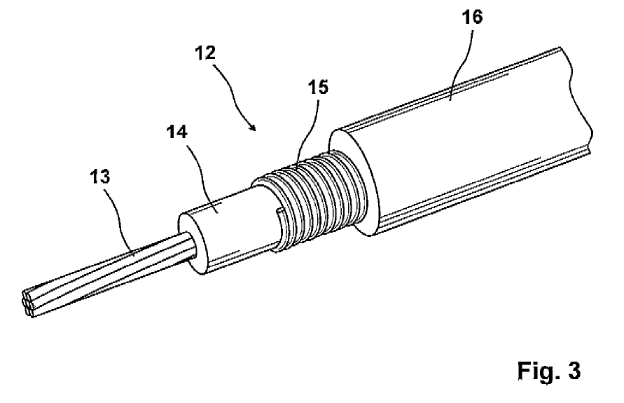

In the FIGS. 1 and 2, there is illustrated a fluid supply hose 1 for a windscreen or headlamp washer system of a vehicle inside of which there is laid a heating element implemented in the form of a coaxial cable 2. This coaxial cable comprises an inner conductor 3 surrounded by an insulator 4 and an outer conductor 5 protected by a water-tight and electrically non-conducting sheath 6. The inner conductor 3 is formed from several twisted braids whilst the outer conductor 5 surrounding the insulator 4 is formed from a meshwork of several braids. It is thereby advantageous that the resistance of the outer current conductor 5 is bigger than the resistance of the inner current conductor 3 so that more heat is generated at the outer current conductor 5 and can be utilized for heating the fluid 7 surrounding the coaxial cable 2.

In another embodiment that has not been illustrated herein, the resistance of the inner current conductor is greater than the resistance of the outer current conductor. As a result, the coaxial cable can be implemented to be thinner, thus occupying less space in the fluid supply hose.

The coaxial cable comprises a distal and a proximal end, a plug contact that has not been illustrated in closer detail herein being provided at the proximal end of the coaxial cable 2, both on the inner current conductor 3 and on the outer current conductor 5, to connect the coaxial cable 2 to a current source. At the distal end of the coaxial cable 2, the inner current conductor and the outer current conductor 5 are electrically connected together so as to allow for current throughflow. At this point, the distal end is provided with a protecting sheath 8 intended as an insulation to protect the current conductors 3, 5 against humidity.

It is understood that the coaxial cable 2 is laid in the entire fluid supply hose in order to protect the overall windscreen or headlamp washer system and to prevent the fluid from freezing.

In FIG. 3, there is illustrated another embodiment of a coaxial cable 12 that is utilized as a heating element in the fluid supply hose and comprises an inner current conductor 13 made from a copper-nickel alloy. About the current conductor 13, there is disposed an insulator 14, made for example from PTFE and surrounded by the outer current conductor 15 so as to cover 95% of the insulator 14. This current conductor 15 is configured to be a nickel-plated copper braid the resistance of which is lower than the resistance of the inner current conductor 13. The resistance of the inner current conductor 13 is about 50 times the resistance of the outer current conductor 15.

In another embodiment, the resistance of the inner current conductor may also be greater by factor of 30 or, in still another embodiment, even greater by factor of 70 than the resistance of the outer current conductor. About this outer current conductor 15 there is wrapped an insulating sheath 16 so that the coaxial cable 12 may be surrounded by water or by a water-like solution and still function properly.

The inner current conductor 13 is formed from a copper-nickel alloy, in particular a CuNi2 alloy. CuNi2 is preferably utilized with relatively long fluid supply hoses as they are found in large cars where a relatively high heating power is needed. Through the CuNi2, a relatively high resistance can be achieved in the inner current conductor without having to increase the diameter of the coaxial cable.

In smaller cars, the entire windscreen and headlamp washer system is of a smaller design so that the fluid supply hose is also smaller. As a result, less heating power is needed. In this case, it also makes sense to reduce the heating power of the heating element and as a result thereof the resistance of the inner current conductor of the coaxial cable. Since however the fluid supply hose itself has the same size for all the models, it is also desirable to utilize a coaxial cable of the same size for all the car models. For this reason, in accordance with the invention, the alloy of the inner current conductor is changed in such a manner that the resistance is lower in this case; for smaller vehicles for example, the copper nickel alloy CuNi10 is utilized.

It is understood that other copper nickel alloys having a different nickel content, such as CuNi6, may be utilized for other types of vehicles.

List of Numerals:

| | |
|---|---|
| 1 | fluid supply hose |
| 2 | coaxial cable |
| 3 | inner current conductor |
| 4 | insulator |
| 5 | outer current conductor |
| 6 | sheath |
| 7 | fluid |
| 8 | protecting sheath |

We claim:

1. A fluid supply hose for a windscreen or headlamp washer system of a vehicle with an electric heating element, said heating element comprising:
a coaxial cable having an inner current conductor and an outer current conductor surrounding said inner current conductor;
an insulator being provided between said inner and said outer current conductor; and
wherein said inner current conductor has a higher electric resistance than the outer current conductor.

2. A fluid supply hose as set forth in claim 1, wherein the inner current conductor is formed from a copper-nickel alloy.

3. A fluid supply hose as set forth in claim 2, wherein the copper-nickel alloy is at least one of CuNi2, CuNi6, or CuNi10.

3. A fluid supply hose as set forth in claim 1, wherein the outer current conductor is wrapped about the insulator.

4. A fluid supply hose as set forth in claim 1, wherein the outer current conductor covers the insulator over about 80 to 98 percent.

5. A fluid hose as set forth in claim 1, wherein the outer current conductor covers the insulator over approximately 95 percent.
